(19) United States
(12) Patent Application Publication
(10) Pub. No.: US 2010/0161744 A1
(43) Pub. Date: Jun. 24, 2010

(54) SYSTEM AND METHOD FOR MOVING DIGITAL CONTENTS AMONG HETEROGENEOUS DEVICES

(75) Inventors: Jong Pil KIM, Daejeon (KR); Sung Ik Jun, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/607,610

(22) Filed: Oct. 28, 2009

(30) Foreign Application Priority Data
Dec. 18, 2008 (KR) 10-2008-0129456

(51) Int. Cl. G06F 15/16

(52) U.S. Cl. 709/206; 709/219

(57) ABSTRACT

Provided are a system and a method for moving digital contents among heterogeneous devices. The system moves digital contents among heterogeneous devices using a remote controller and includes a movement instructing device that moves digital contents from a first device to a second device a server that is connected with the first device and the second device by a network and performs wireless communication with the movement instructing device.

### CROSS-REFERENCE TO RELATED APPLICATION

This application claims priority to and the benefit of Korean Patent Application No. 10-2008-0129456 filed in the Korean Intellectual Property Office on Dec. 18, 2008, the entire contents of which are incorporated herein by reference.

### BACKGROUND OF THE INVENTION

(a) Field of the Invention

The present invention relates to a system and a method for moving digital contents among heterogeneous devices.

(b) Description of the Related Art

Recently, it has been possible to provide digital contents using various devices. In other words, it is possible to directly play video files or music files, which could be played only by computers, on TVs, audio sets, and mobile terminals. Further, with the development of the home network technology, various appliances are connected by a network, such that it has been convenient to move digital contents among heterogeneous devices.

However, the user interface that moves digital contents is still implemented by the drag and drop method of Windows. This is described with reference to FIG. 1.

FIG. 1 is an exemplary view illustrating a method of moving digital contents among common heterogeneous devices.

FIG. 1 shows that a folder 20 of a second appliance that provides digital contents and a folder 30 of a third appliance that receives the digital contents are shown on a display 10 of a first appliance. The first appliance, the second appliance, and the third appliance are connected by a network or USB cables etc.

As a user selects digital contents to move from the second appliance folder 20 and moves the selected digital contents to the third appliance folder 30 in the drag and drop method, the actual digital contents are moved from the second appliance to the third appliance.

When digital contents are moved in this way, the use needs a specific device for display, such as the first appliance. Further, the first appliance needs to find the third appliance where the digital contents are moved.

For example, assuming that the second appliance and the third appliance are audio sets, it is intuitive to extract a compact disc inserted in the second appliance and insert it into the third appliance, as compared with moving digital contents between folders, such that moving digital contents between folders is an abstract conception and the intuition is deteriorated. The intuition herein implies that directly inserting a CD into an audio set to play music is better than clicking a music file on the computer display or playing music by the drag and drop method, in order for the user to listen to the music.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and a method for moving digital contents among heterogeneous devices using a remote controller.

An exemplary embodiment of the present invention provides a method of moving digital contents from a first device to a second device, which includes:

recognizing a first device identification signal outputted from the first device; calculating first pointing information including pointing coordinates of the first device; transmitting on state information of a predetermined button to a server to move digital contents from the first device to the second device; and recognizing a second device identification number outputted from the second device and calculating second pointing information including pointing coordinates of the second device.

Another embodiment of the present invention provides a method of moving digital contents, which receives digital contents of a first device which are moved by a remote controller, which includes:

determining that the state of a predetermined button of the remote controller is changed; determining whether the predetermined button is off, when the state of the predetermined button has been changed; receiving information on digital contents selected by the predetermined button, digital contents process information, and pointing coordinates from a server, when the present state is off; and displaying the digital contents.

Another embodiment of the present invention provides a system for moving digital contents from a first device to a second device, which includes: a movement instructing device that moves digital contents from the first device to the second device; and a server that is connected with the first device and the second device by a network and performs wireless communication with the movement instructing device.

### BRIEF DESCRIPTION OF THE DRAWINGS

FIG. 1 is an exemplary view illustrating a method of moving digital contents among common types of devices.

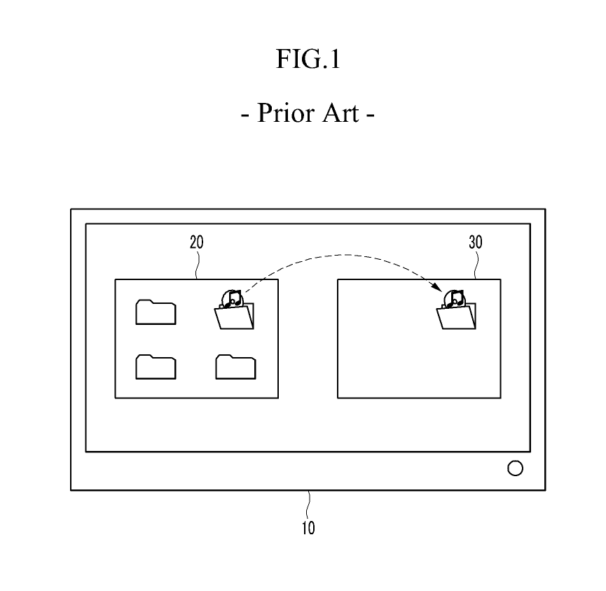

FIG. 2 is an exemplary view of a digital contents movement environment according to an exemplary embodiment of the present invention.

FIG. 3 is a configuration diagram of a digital contents movement environment according to an exemplary embodiment of the present invention.

FIG. 4 is a flowchart illustrating a method of moving digital contents among heterogeneous devices according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising” will be understood to imply the inclusion of stated elements but not the exclusion of any other elements.

Hereinafter, a system and a method for moving digital contents among heterogeneous devices according to an exemplary embodiment of the present invention are described in detail with reference to the accompanying drawings.

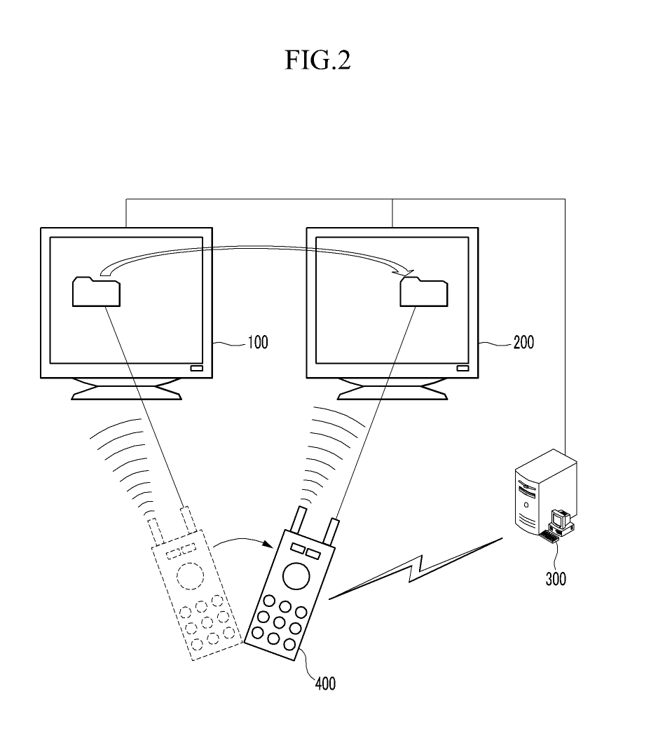

FIG. 2 is an exemplary view of a digital contents movement environment according to an exemplary embodiment of the present invention.

As shown in FIG. 2, a first device 100 and a second device 200 are heterogeneous devices connected with a server 300 by a wire or wireless network, and a movement instructing device needed for moving digital contents between the first device 100 and the second device 200 is provided. Further, in an exemplary embodiment of the present invention, for convenience of description, it is exemplified that only two heterogeneous devices (first device 100 and second device 200) are connected to the server 300 by a network, and a remote controller 400 is exemplified as the movement instructing device, but it is not limited thereto.

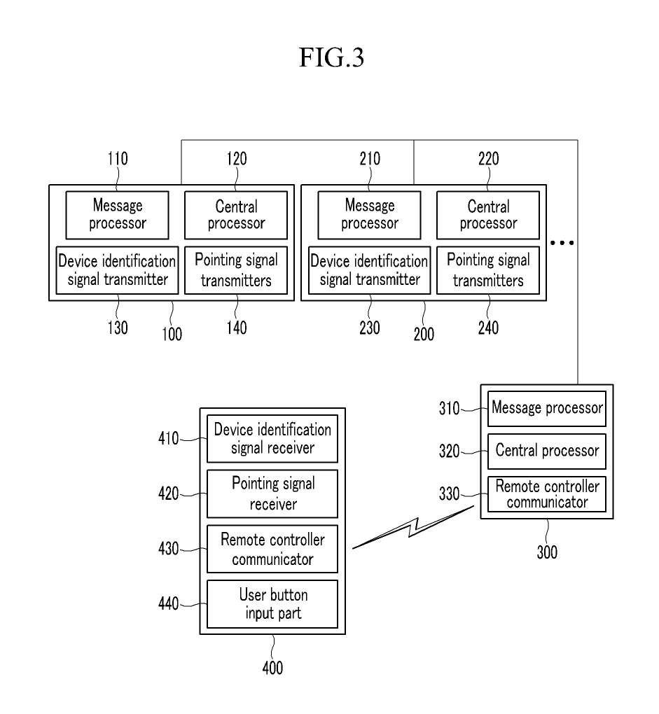

The detailed configuration of each constituent element is described with reference to FIG. 3.

FIG. 3 is a configuration diagram of a digital contents movement environment according to an exemplary embodiment of the present invention.

First, describing the configuration of the first device 100 or the second device 200 that can store digital contents and provides the digital contents to a user, the devices according to an exemplary embodiment of the present invention include message processors 110 and 210, central processors 120 and 220, device identification signal transmitters 130 and 230, and pointing signal transmitters 140 and 240, respectively.

The message processors 110 and 120 process messages transmitted/received to/from other heterogeneous devices or the server 300 that are connected by a network. The processed messages include digital contents copy and movement information, digital contents information, remote controller switch on/off information, and remote controller pointing information, but they are not necessarily limited thereto.

The central processors 120 and 220 process pointing information sent from the remote controller 400 and perform the process of movement of digital contents, such as transmitting or receiving the digital contents to/from other devices connected by the network, such as the first device 100 and the second devices 200. Further, the central processors 120 and 220 execute the digital contents and provide them to a user. The digital contents may be executed by a specific content executor, or may be processed by the central processors 120 and 220 in the exemplary embodiment of the present invention.

The device identification signal transmitters 130 and 230 store the identification numbers allocated in advance in the devices, and transmit the identification numbers when other devices or the server 300 requests them.

The pointing signal transmitters 140 and 240 calculate the pointing position that the remote controller 400 indicates. An infrared light signal can be used to calculate the pointing position, but it is not necessarily limited thereto. A method of calculating the pointing position has been known in the art and the detailed description is not provided in the exemplary embodiment of the present invention.

Next, the server 300 connected with the first device 100 and the second device 200 by the network shown in FIG. 2 controls the network connecting the remote controller 400 with the first device 100 or the second device 200, and controls movement of the digital contents. Describing the configuration of the server 300, the server 300 includes a message processor 310, a central processor 320, and a remote controller communicator 330.

The message process 310 of the server processes messages transmitted/received to/from the first device 100 or the second device 200 through the network. The processed messages are the same as the messages staged in relation to the message processors 110 and 210 of the first device 100 or the second device 200, which is described above.

When a user selects digital contents to move from any one of the first device 100 and the second device 200 to the other device using the remote controller, the central processor 320 temporarily stores the information of the selected digital contents. Further, when the user selects a device to where the selected digital contents are moved, the central processor 320 transmits the information of the temporarily stored digital contents (e.g. movie file information or music file information) to the corresponding device, together with pointing information. The pointing information implies information including pointing coordinates.

When the device receiving the digital contents cannot process the digital contents, the central processor 320 changes the digital contents to be processed by the device. For example, in order to move and play a high-quality video file stored in a computer in a portable multimedia player (PMP), the central processor 320 automatically converts the high-quality video file into a file having quality suitable for the PMP and moves it.

The remote controller communicator 330 receives signals outputted from the remote controller 400 and transmits them to the central processor 320.

Next, the remote controller 400 according to an exemplary embodiment of the present invention shown in the FIG. 2 receives signals transmitted from the device identification signal transmitters 130 and 230 through the device identification signal receiver, and determines to operate as an input device for a device. Further, the remote controller 400 also calculates information on pointing to a portion of the device. For this operation, the remote controller 400 includes a device identification signal receiver 410, a pointing signal receiver 420, a remote controller communicator 430, and a user button input part 440.

The device identification signal receiver 410 identify signals including the identification numbers transmitted from the device identification signal transmitters 130 and 230 of the first device 100 or the second device 200 and stores the last identified identification number. The remote controller 400 can determine to operate as an input device for which device now, by identifying the identification numbers. For a signal for identifying the devices, infrared light communication, Bluetooth communication, etc., can be used, and this is not necessarily limiting.

The pointing signal receiver 420 identifies pointing signals transmitted from the pointing signal transmitters 140 and 240 of the devices. By identifying the pointing signals, it is possible to calculate to which position of the devices the remote controller points. For the pointing signal, methods of using infrared light and a camera can be used, and this is not limiting as long as the method satisfies calculation of the pointing information.

The remote controller communicator 430 is used to communicate with the server 300 through the network. For example, when a user selects digital contents, the remote controller communicator 430 transmits the corresponding information of the digital contents to the server 300 to store it. A wireless network is exemplified in the exemplary embodiment of the present invention, but this is not necessarily limiting.

The user button input part 440 controls digital contents on the basis of the operation of the button inputted by the user. For example, the user button input part 440 makes it possible to select digital contents when a user presses a predetermined button, and to move the digital contents when the user releases the button.

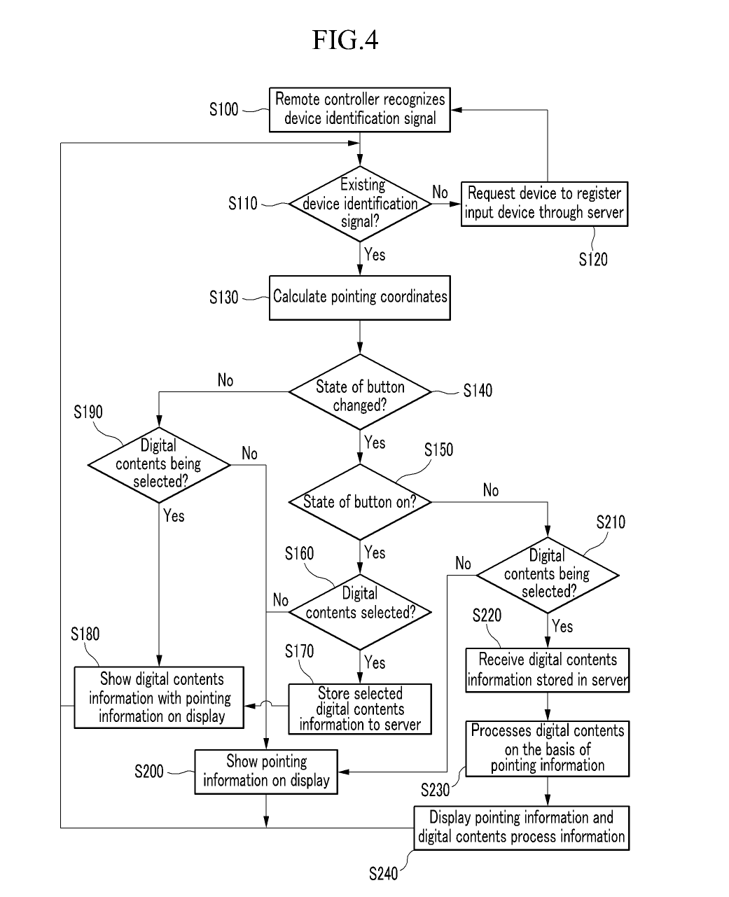

A method of moving digital contents among heterogeneous devices using the system described above is described with reference to FIG. 4. For better comprehension and ease of description of the method of moving digital contents among heterogeneous devices according to an exemplary embodiment of the present invention, it is assumed that the digital contents of the first device 100 are moved to the second device 200.

FIG. 4 is a flowchart illustrating a method of moving digital contents among heterogeneous devices according to an exemplary embodiment of the present invention.

As shown in FIG. 4, the device identification signal receiver 410 of the remote controller 400 recognizes the identification signal outputted from the device identification transmitter 130 of the first device 100 (S100). The device identification signal receiver 410 determines whether the recognized identification signal is an existing identification signal, that is, if the identification number included in the identification signal is the identification number stored in itself in advance (S110). The device identification signal receiver 410 compares the identification number of the device stored in itself with the identification number recognized in step S100, thereby performing the determination.

When it is determined that it is not the last identified device as a result of the comparison, the central processor 120 of the first device 100 recognized by the remote controller 400 registers the remote controller 400 as a new input device. Accordingly, the remote controller 400 requests the first device 100 to register itself as an input device through the server 300 (S120). Further, the device identification signal receiver 410 of the remote controller 400 stores the identification number in the device identification signal identified in step S100.

Describing in detail the process of registering the remote controller 400 as an input device by the first device 100, when the remote controller 400 detects the identification number of the first device 100, the remote controller 400 transmits a request message for requesting the first device 100 to register itself as an input device through the server 300, to the first device 100. When the message processor 310 of the server 300 transmits the request message to the first device 100, the message processor 110 of the first device registers the remote controller 400 as an input device.

Meanwhile, as a result of the comparison in step S110, when the device identification signal receiver 410 determines that the signal is the same as the finally identified device, the pointing signal receiver 420 receives a pointing signal and calculates the pointing coordinates (S130). The pointing signal is a signal that the first device 100 outputs through the pointing signal transmitter 140, which is a signal outputted to the remote controller 400, including the point coordinates of the first device 100, which is indicated by the remote controller 400 and calculated by the pointing signal transmitter 140.

Thereafter, the remote controller communicator 430 of the remote controller 400 transmits information on whether a predetermined button is on/off and the pointing coordinates to the remote controller communicator 330 of the server 300. The first device 100 displays the pointing information. The remote controller communicator 330 of the server 300 transmits the information transmitted from the remote controller communicator 430 of the remote controller 400 and the digital contents information stored in the central processor 320 to the first device 100.

The above process was described by exemplifying the process performed between the remote controller 400 and the first device 100, but if the second device 200 is connected through the network, the above process is also performed between the second device 200 and the remote controller 400.

Next, the pointing signal receiver 140 of the first device 100 determines whether the state of the buttons of the remote controller 400 is changed, on the basis of a button state change signal that informs that a predetermined button of the remote controller 400 is turned on or a button state change signal generated when the button is turned off (S140).

When it is determined that the state of the button of the remote controller is changed in the step S140, it is determined whether digital contents have already been selected by a user (S150). When the user has selected a predetermined button of the remote controller, the process after the step S190 which is described below is performed. However, digital contents are not yet selected, so the process after the step S200 which is described below is performed.

On the other hand, when it is determined that the state of the button of the remote controller is changed in the step S140, the central processor 120 of the first device 100 determines whether the state of the corresponding button is changed from the off state to the on state or from the on state to the off state (S150). When the central processor 120 determines that a predetermined button of the remote controller 400 is changed from the off state to the on state, it is determined when the user selects digital contents, on the basis of the pointing coordinates transmitted through the server 300 from the pointing signal receiver 420 (S160). For example, when there are no digital contents at the corresponding pointing coordinates of the first device 100, it means that the user did not select digital contents.

However, when there are digital contents at the position pointed by the remote controller 400, the digital contents are selected by the central processor 120. As described, when the digital contents are selected, the central processor 120 transmits the corresponding digital contents to the server 300 connected by the network, or transmits digital contents information including the positional information of the digital contents to be stored in the central processor 330 of the server 300 (170).

The first device 100 that has received the digital contents or the digital contents information shows the pointing coordinates and the selected digital contents information on the display (S180). For example, if a PC equipped with Windows XP has received the digital content information, in Windows XP, the pointer of the mouse is positioned on the selected item and the color of the item darkens.

Thereafter, when the pointing signal transmitter 140 of the first device 100 receives a pointing signal including information that the button of the remote controller 400 is not turned on in step 150, the central processor 120 recognizes that the button of the remote controller 400 is not turned off. The central processor 120 of the first device 100 determines whether the server 300 transmits digital contents information and whether digital contents have been already selected (S210). It can be known that the user has moved digital contents of the first device 100 to the second device 200 using the remote controller 400, by the determination from step S140 to step S170.

It is assumed that the user moves the corresponding digital contents to the second device 200, when the digital contents in the first device 100 are selected and a predetermined button is turned on. The device identification signal receiver 410 of the remote controller 400 receives device identification information of the second device 200, and the second device 200 registers the remote controller 400 as an input device for itself, as described in step S100 to step S130.

The remote controller 400 registered as an input device for the second 200 transmits the pointing coordinates of the second device 200 outputted from the pointing signal transmitter 240 and the digital contents information stored in the server 300 to the second device 200. When the digital contents are transmitted from the server 300 to the second device 200 or it is determined that the digital contents have already been selected, the second device 200 checks the digital contents information transmitted from the server 300 and takes the corresponding digital contents from the first device 100. For example, when the digital contents information is a music file, the central processor 220 of the second device 200 takes the music file stored in the first device 100 by copying it.

Thereafter, the second device 200 performs a process such that the digital contents are executed in itself with the remote controller 400 registered as an input device, on the basis of the pointing information (S230). When the digital contents are processed, the second device 200 displays the pointing information outputted from the remote controller 400 and the digital contents process information (S240).

In this process, for example in step S230, when the digital contents are music files and there is a player for executing the music files at the pointed position, the music player is allowed to execute the music files, which are digital contents. However, if there is no player, a message for informing the user thereof is displayed and transmitted to the server 300 such that the music files are converted to be played in the second device 200.

Meanwhile, if it is determined that the remote controller 400 does not select digital contents in step S190, the second device 200 shows pointing information on the display (S200). Thereafter, the second device stands by the process after step S100.

According to the embodiments of the present invention, since it is possible to move digital contents among heterogeneous devices using a remote controller in a drag and drop method, a user can effectively and conveniently move digital contents.

The above-mentioned exemplary embodiments of the present invention are not embodied only by an apparatus and method. Alternatively, the above-mentioned exemplary embodiments may be embodied by a program performing functions that correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of moving digital contents from a first device to a second device, comprising:
recognizing a first device identification signal outputted from the first device;
calculating first pointing information including pointing coordinates of the first device;
transmitting state information indicating whether a predetermined button is turned on to a server to move digital contents from the first device to the second device; and
recognizing a second device identification number outputted from the second device and calculating second pointing information including pointing coordinates of the second device.

2. The method of moving digital contents of claim 1, wherein the calculating of first pointing information includes:
determining whether the recognized first device identification signal is a signal of a device that has already been recognized; and
calculating the pointing information about the first device, when the signal is a signal of a device that has already been recognized.

3. The method of moving digital contents of claim 2, wherein the transmitting state information transmits the calculated pointing information and the state information of the predetermined button to the server.

4. The method of moving digital contents of claim 2, further comprising requesting the server to register an input device for the first device, when the recognized device identification signal is for a device that is not recognized.

5. The method of moving digital contents of claim 1, wherein the calculating second pointing information includes:
recognizing a second device identification signal outputted from the second device; and
requesting the server to register an input device for the second device, when the second device identification signal is a signal for a device that is not recognized after determining whether the second device identification signal is for the device that has already been recognized.

6. A method of moving digital contents, which receives digital contents of a first device that are moved by a remote controller, comprising:
determining whether the state of a predetermined button of the remote controller is changed;
determining whether the predetermined button is off, when the state of the predetermined button is changed;
receiving information on digital contents selected by the predetermined button, digital contents process information, and pointing coordinates from a server, when the present state is off; and
displaying the digital contents.

7. The method of moving digital contents of claim 6, further comprising:
when the state of the predetermined button is not changed or the present state of the predetermined button is not off,
determining whether digital contents have been selected;
storing selected digital contents information in the server, when digital contents have been selected; and
displaying the selected digital information and pointing information.

8. The method of moving digital contents of claim 7, further comprising displaying the pointing information when the digital contents have not been selected.

9. A system for moving digital contents from a first device to a second device, comprising:
a movement instructing device that moves digital contents from the first device to the second device; and
a server that is connected with the first device and the second device by a network and performs wireless communication with the movement instructing device.

10. The system for moving digital contents of claim 9, wherein the first device includes:
a message processor that processes a message that is transmitted/received to/from the second device or the server, the message including any one of copy and movement information of digital contents, digital contents information, on/off information of the switch of the remote controller, and pointing information of the remote controller;
a central processor that processes pointing information transmitted from the remote controller and performs a process of moving the digital contents when transmitting the digital contents to the second device;
a device identification signal transmitter that stores an identification number that is allocated in advance to the first device, and transmits a device identification signal including the identification number when the second device or the server makes a request; and
a pointing signal transmitter that calculates coordinates of a pointing position indicated by the movement instructing device.

11. The system for moving digital contents of claim 10, wherein the server includes:
a message processor that processes a message that is transmitted/received to/from the first device or the second device;
a central processor that, when digital contents to be moved from any one of the first device and the second device to the other device are selected by the movement instructing device, temporally stores information of the selected digital contents including movie file information or music file information and then transmits the information of the temporally stored digital contents together with pointing information to the device where the digital contents are moved; and
a movement instructing communicator that receives a signal outputted from the movement instructing device and transmits the signal to the central processor.

12. The system for moving digital contents of claim 9, wherein the movement instructing device includes:
a device identification signal receiver that receives a device identification signal outputted from the first device or the second device and stores an identification number included in the device identification signal;
a pointing signal receiver that receives a pointing signal outputted from the first device or the device signal and calculates pointing information from the received pointing signal;
a user button input part that, when input information is generated from a predetermined button, controls digital contents on the basis of the generated input information; and
a movement instructing communicator that communicates with the server.

13. The system for moving digital contents of claim 12, wherein the movement instructing device is a remote controller.
